(19) United States
(12) Patent Application Publication
(10) Pub. No.: US 2010/0106561 A1
(43) Pub. Date: Apr. 29, 2010

(54) Forecasting Using Share Models And Hierarchies

(76) Inventors: Sergiy Peredriy, Chapel Hill, NC (US); Yung-Hsin Chien, Apex, NC (US); Arin Chaudhuri, Raleigh, NC (US); Ann Mary McGuirk, Raleigh, NC (US); Yongqiao Xiao, Cary, NC (US)

Correspondence Address: Patent Group 2N;Jones Day, North Point, 901 Lakeside Avenue, Cleveland, OH, 44114, US

(21) Appl. No.: 12/259,676

(22) Filed: Oct. 28, 2008

(51) Int. Cl. G06Q 10/00

(52) U.S. Cl. 705/10

(57) ABSTRACT

Computer-implemented systems and methods are provided for forecasting product sales. Market shares associated with a product are estimated. Sales for a share group are forecast based upon a seasonality component and a trend prediction. A product sales forecast is calculated based upon the forecasted sales for a share group and the estimated product market share.

### TECHNICAL FIELD

This document relates generally to product demand forecasting and more particularly to forecasting demand using hierarchical data.

### BACKGROUND

Demand forecasting is the activity of estimating the quantity of a product or service that consumers will purchase. This activity may involve techniques including both informal methods (such as educated guesses) as well as quantitative methods, such as analysis of historical sales data or current data from test markets. Despite advancements in this field, greater accuracy is needed for improving the analysis associated with demand forecasting.

### SUMMARY

In accordance with the teachings provided herein, computer-implemented systems and methods are provided for forecasting product sales utilizing historic product data that is organized with respect to a geography hierarchy and a product hierarchy. As an illustration, a computer-implemented system and method are provided herein for forecasting product sales. Market shares associated with a product are estimated. Sales for a share group are forecast based upon a seasonality component and a trend prediction. A product sales forecast is calculated based upon the forecasted sales for a share group and the estimated product market share.

As another illustration, historic product data may be received from a computer-readable data store. A seasonality component may be estimated based upon aggregate data from a first level of the geography hierarchy and a first level of the product hierarchy. A trend prediction may be forecast based upon aggregate data from a second level of the geography hierarchy and a second level of the product hierarchy. The second level of the geography hierarchy may be at an equal or more detailed level in the geography hierarchy than the first level of the geography hierarchy, or the second level of the product hierarchy may be at an equal or more detailed level in the product hierarchy than the first level of the product hierarchy. For a product within a share group, a market share may be estimated that is associated with the product with respect to other items in the share group. Sales for a share group may be forecasted based upon the seasonality component and the trend prediction, where a share group is a collection of related products. For the product within a share group, a product sales forecast may be calculated based upon the forecasted sales for a share group and the estimated product market share. The calculated product sales forecast may be stored in a computer-readable data store. The receiving, forecasting a seasonality prediction, forecasting a trend prediction, forecasting sales, estimating a market share, calculating a product sales forecast, and storing may all be performed on one more data processors.

As a further example, computer-implemented systems and methods for forecasting product sales utilizing historic product data that is stored with respect to a geography hierarchy and a product hierarchy may include a computer-readable data store for housing the historic product data. A seasonality estimator may be configured to estimate a seasonality component based upon aggregate data from a first level of the geography hierarchy and a first level of the product hierarchy. A trend forecaster may be configured to make a trend prediction based upon aggregate data from a second level of the geography hierarchy and a second level of the product hierarchy. The second level of the geography hierarchy may be at an equal or more detailed level in the geography hierarchy than the first level of the geography hierarchy, or the second level of the product hierarchy may be at an equal or more detailed level in the product hierarchy than the first level of the product hierarchy. A market share estimator may be configured to estimate, for a product within a share group, a market share associated with the product with respect to other items in the share group. A sales forecaster may be configured to forecast sales for a share group based upon the seasonality component and the trend prediction, where a share group is a collection of related products. A product sales forecast calculator may be configured to calculate, for the product within a share group, a product sales forecast based upon the forecasted sales for a share group and the estimated product share, and the calculated product sales forecast may be stored in a computer-readable data store

### BRIEF DESCRIPTION OF THE DRAWINGS

FIG. 1 is a block diagram depicting a computer-implemented environment for forecasting product sales utilizing historic product data that is stored with respect to a geography hierarchy and a product hierarchy.

FIG. 2 is a block diagram depicting an example geography hierarchy.

FIG. 3 depicts an example product hierarchy and example contents of a product hierarchy.

FIG. 4 depicts an example share group structure and example share group contents.

FIG. 5 depicts example product shares for a share group.

FIG. 6 is a block diagram depicting a share model sales forecasting system.

FIG. 7 is a block diagram depicting further details of a share group predictor.

FIG. 8 is a block diagram of a model sales forecasting system and the levels used for making seasonality estimates and trend predictions.

FIG. 9 depicts complementary share groups.

FIG. 10 depicts competing share groups.

FIG. 11 is a block diagram depicting the integration of secondary effects in the share model forecasting system.

FIG. 12 depicts level selection for a seasonality estimation.

FIG. 13 depicts level selection for seasonality estimation.

FIG. 14 is a flow diagram illustrating calculation of product sales forecasts utilizing hierarchical data.

FIG. 15 is a block diagram depicting an environment wherein a user can interact with a share model sales forecasting system.

### DETAILED DESCRIPTION

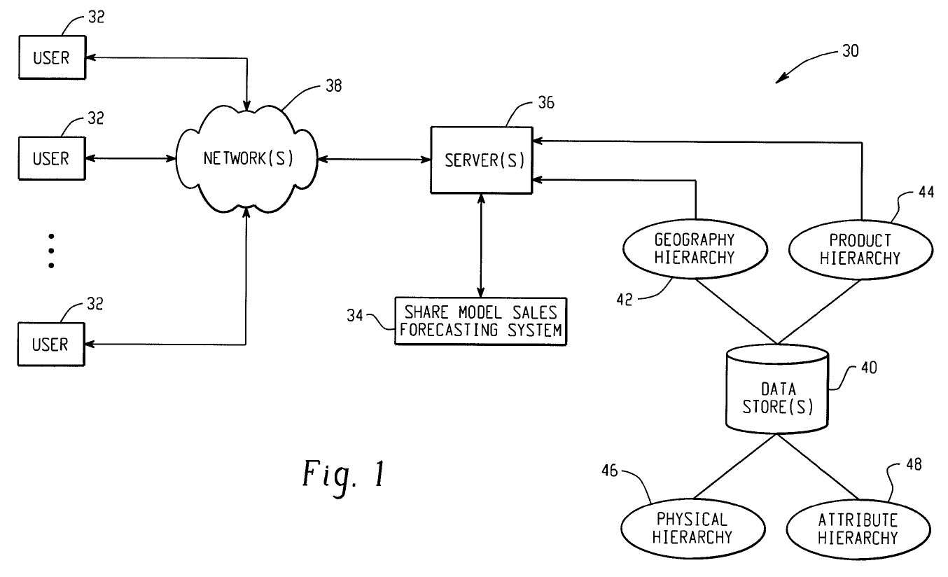

FIG. 1 is a block diagram depicting a computer-implemented environment for forecasting product sales utilizing historic product data that is stored with respect to a geography hierarchy and a product hierarchy. FIG. 1 depicts at 30 an environment wherein users 32 can interact with a share model sales forecasting system 34 hosted on one or more servers 36 through a network 38. The share model sales forecasting system 34 computes forecasted sales using historic product data that is stored in one or more data stores 40. The historic sales data used by the share model sales forecasting system 34 is organized with respect to a geography hierarchy 42 and a product hierarchy 44.

The historic sales data may be hierarchically stored within the one or more data stores 40 in the geography hierarchy 42 and product hierarchy 44 formats, or the geography hierarchy 42 and product hierarchy 44 formats may be model hierarchies that are based upon one or more physical hierarchies 46 and attribute hierarchies 48 stored in the one or more data stores 40. Generation of a model hierarchy based upon one or more physical and attribute hierarchies is described in co-owned application Ser. No. 12/241,784, entitled “Attribute-based Hierarchy Management for Estimation and Forecasting,” filed Sep. 30, 2008, which is herein incorporated in its entirety by reference.

A share model may be used in commercial applications to capture how the sales of a group of products interact with each other. The share model sales forecasting system 34 models the effect of primary demand drivers, such as seasonality and trends, using a share model within a hierarchical setting. This system 34 enables users 32 to estimate the primary demand drivers at different levels in the product and geography hierarchies, enabling users 32 to capture the effects of the primary demand drivers at points in the hierarchy where data provides the richest information. In addition, the system 34 enables users 32 to model secondary demand effects which occur across share groups, such as cannibalization and/or halo effects across interacting share groups.

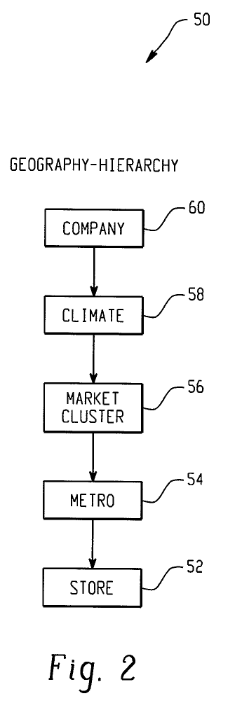

FIG. 2 is a block diagram depicting an example geography hierarchy. The example geography hierarchy 50 contains five levels, with the store level 52 being the lowest and most detailed level. Each member of the store level 52 has a parent member in the metro level 54. Each member of the metro level 54 contains aggregate data based on the lower level members which are contained within the member of the metro level 54. For example, the ‘Dallas’ node in the metro level may contain aggregate sales data for all stores within the Dallas metro area, which reside on the store level. Similarly, parent-child relationships and associated aggregate data run to the market cluster level 56 from the metro level 54; to the climate level 58 from the market cluster level 56; and to the company level 60 from the climate level 58.

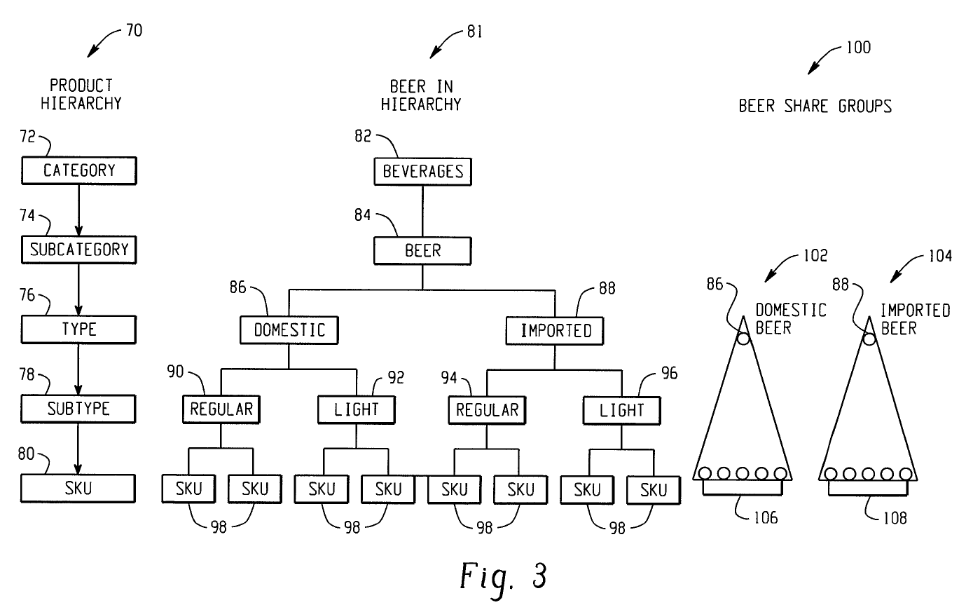

FIG. 3 depicts an example product hierarchy and example contents of a product hierarchy. The example product hierarchy 70 contains five levels. The highest level, the category level 72, contains the subcategory level 74, which contains the type level 76. The type level 76 contains the subtype level 78, which contains the lowest and most detailed level, the SKU (stock keeping unit) level 80. The beer hierarchy 81 illustrates example contents for each of the levels of the product hierarchy 70. The category of the hierarchy that contains beer is beverages 82, with beer 84 being the subcategory. The beer subcategory 84 is broken into two types, domestic 86 and imported 88. Each of the types is broken down into subtype branches, regular 90, 94 and light 92, 96. Each of the subtypes contains one or more members 98 at the SKU level.

A share group is a collection of products that compete against one another. The members of a share group compete in that a consumer tends to choose from among the products in the group when making a purchase. A share group may also be termed a choice set, which is a set of products from which the customer chooses. In a hierarchy perspective, the share group may be thought of as a parent node and its child nodes, where the child nodes are all products that compete with one another. For example, consumers looking for a cola are typically choosing from among all the products with sugar (regular cola) or among all of the products without sugar (diet cola). Because consumers tend to choose products from within one of these groups that meets their sugar/no sugar needs, the product level that splits regular cola from diet cola forms a good level for defining a share group. Thus, a share group can consist of the Regular Cola parent node, and the Coke™, Pepsi™, RC Cola™, and Store Brand Cola child nodes.

FIG. 3 illustrates two beer share groups at 100. The share groups have been chosen at the type level such that the domestic beer node 86 heads the domestic beer share group 102 and the imported beer node 88 heads the imported beer share group. The lower level nodes 106 of the domestic beer share group 102 that compete among one another are the members of the domestic beer share group 102. Similarly, the lower level nodes 108 of the imported beer share group 104 that compete among one another are the members of the imported beer share group 104.

It should be noted that the level definitions of share groups and share group members may be altered based upon prior gathered data and analysis needs. For example, if it is determined that customers tend to select beers based on the subtype rather than the type level, then share groups may be selected at the subtype level. In the example of FIG. 3, this would result in four share groups: domestic regular, domestic light, imported regular, and imported light. The level at which share group members are selected may also differ depending on application. For example, it may be necessary to determine total demand for regular and light beers without concern for individual SKUs. In this application, the share groups would be defined at the type level and the member nodes would be defined at the subtype level.

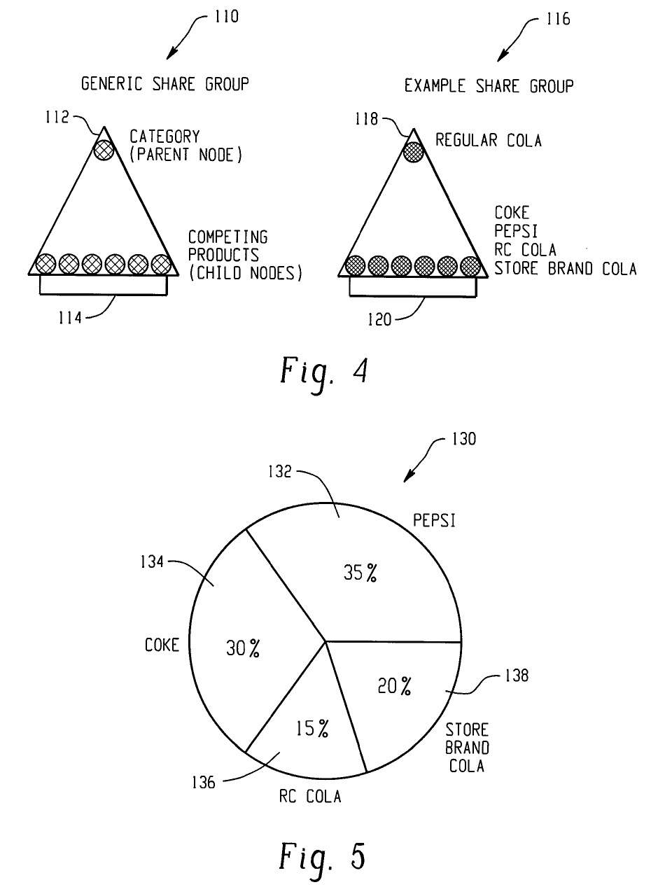

FIG. 4 depicts an example share group structure and example share group contents. As described above and shown in the generic share group 110, a share group is made up of a parent node 112 that defines the category and a plurality of child nodes 114 that include a plurality of products hierarchically subordinate to the parent node 112 that compete among one another. An example share group is shown at 116 that is defined by the regular cola parent node 118. A plurality of child nodes 120 define the members of the regular cola share group that include Coke, Pepsi, RC Cola, and Store Brand Cola.

The share group is defined by the product hierarchy. The geography hierarchy serves as the aggregation dimension, such that the share group prediction model and the market share model may be calibrated at a higher aggregation level to improve the quality and robustness of the model parameter estimates.

The share model, described above, captures how the sales of a group of products interact with each other. The share model may be used to generate predicted demand for a particular share group. While this predicted demand is useful in some respects, it does not include a prediction for individual members within a share group.

The product share is a prediction of the relative amount, which may be expressed as a percentage, of each product in a share group that will be sold. The product shares for all products in a share group whose shares are expressed as a percentage are equal to 100% or an equivalent (e.g., total shares are equal to 1 if individual shares are expressed as a ratio of individual share to total shares such that individual shares fall between 0 and 1). The product share is a relative value. This is in contrast to the share group total demand, which is an absolute value. Thus, the product share does not indicate scale. Product A with a 30% product share could account for 3 units per week or 3000 units per week, depending on the share group total demand.

FIG. 5 depicts example product shares for a share group. The pie chart 130 of FIG. 5 illustrates example individual product shares for Pepsi 132, Coke 134, RC Cola 136, and Store Brand Cola 138. The product shares represent an individual product's share of the total regular cola share group. The individual shares are relative to the total share group. Thus, the total of all product shares within the share group equals 100%. As noted above, actual predicted demand or sales can not be gleaned from the product shares depicted in FIG. 5. These product shares are be combined with a share group predicted demand or share group predicted sales to generate absolute predicted demand or sales values.

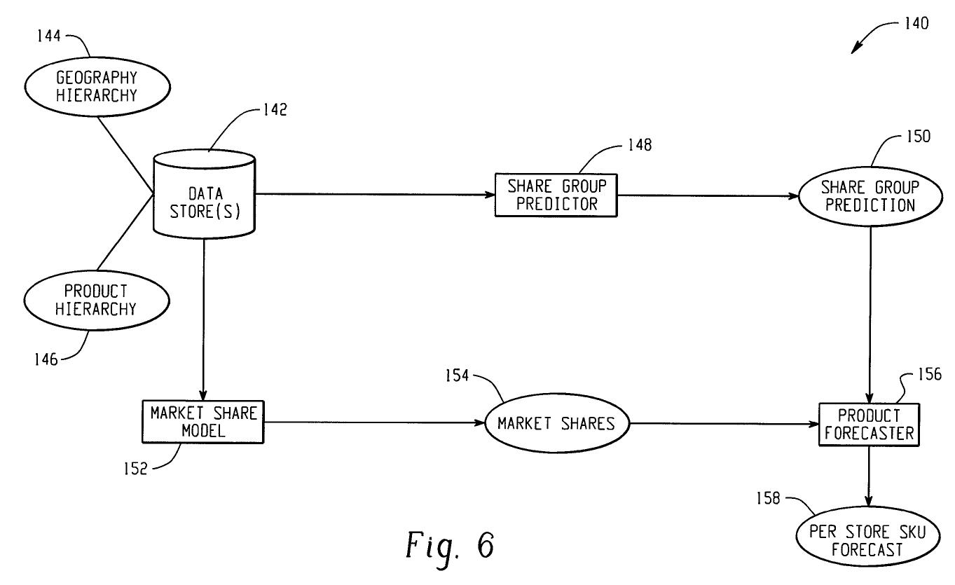

FIG. 6 is a block diagram depicting a share model sales forecasting system 140. Historical data is retained in the one or more data stores 142. As noted above, this historical data may be stored in the geography hierarchy 144 and product hierarchy 146 formats within the data store 142, or the geography hierarchy 144 and product hierarchy 146 may be model hierarchies generated for use in the share model sales forecasting system 140. The share model forecasting system 140 executes over two branches that may be processed sequentially or in parallel. The first branch includes a share group predictor 148, which receives the geography hierarchy 144 and product hierarchy 146 data and uses the received data to generate a sales or demand prediction 150 for an entire share group. For example, the share group predictor 148 may predict the demand for the regular cola share group at 100,000 units for the Dallas area for July.

The second branch of the share model sales forecasting system 140 includes a market share model 152. The size of the share of each product is a measure of the product's attraction, which can be modeled as a function of product attributes, such as brand loyalty, the product's price and promotions, and other products' prices and promotions. The market share model may be implemented as a mixed regression model that incorporates product attributes and marketing mix with historic data from the geography hierarchy 144 and product hierarchy 146 to generate individual market shares 154 for the members of the share group. For example, the market share model 152 may generate market shares 154 such as those depicted in and discussed with reference to FIG. 5 for the regular cola share group.

The generated share group prediction 150 and market shares 154 are received by a product forecaster 156. The product forecaster 156 calculates individual absolute demand or sales predictions by multiplying the predicted demand or sales for the entire share group by one or more of the individual market shares. The calculated absolute values are output, for example, as a per store SKU forecast 158. As noted above, the use of the hierarchical structures of the geography and product hierarchies enables definition of share groups and share group members at various levels of the hierarchies enabling forecasts to be made at different levels depending on the application and data sufficiency.

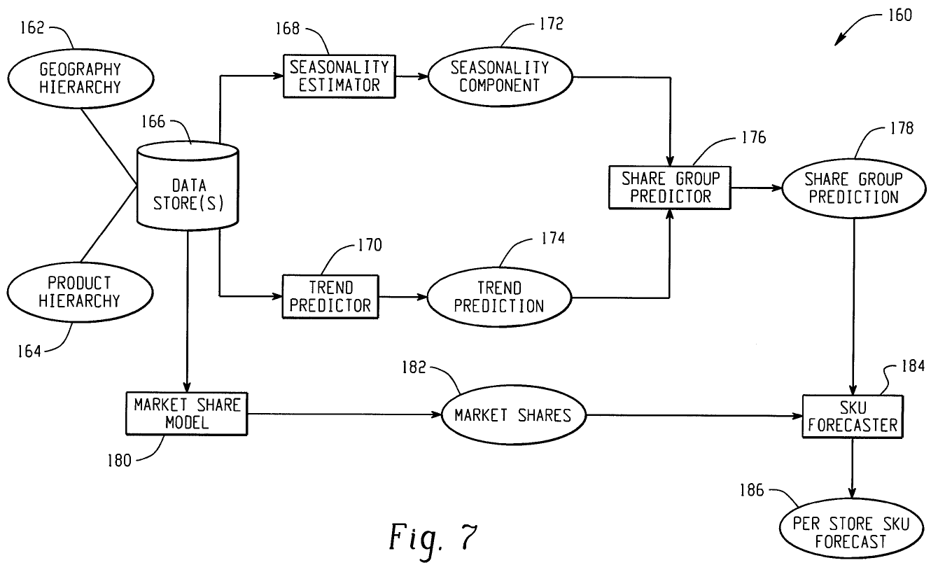

FIG. 7 is a block diagram depicting further details of a share group predictor. The share group predictor shown in FIG. 6 is broken down into example component parts in FIG. 7. In the example of FIG. 7, the geography hierarchy 162 and product hierarchy 164 are received from the one or more data stores 166, as previously described, by a seasonality estimator 168 and a trend predictor 170. The seasonality estimator 168 and trend predictor 170 generate a seasonality component 172 and a trend prediction 174, respectively, that represent two of the primary demand drivers for a share group. The estimated seasonality component 172 and the trend prediction 174 are received by the share group predictor 176, which utilizes the received seasonality component 172 and trend prediction 174 to generate a share group prediction 178 that may identify predicted baseline sales or demand for an entire share group.

As was described with respect to FIG. 6, the market share model 180 receives historical, attribute, and other data from the one or more data stores 166 and uses the received data in generating individual market shares 182 for each of the members of the share group at issue. An SKU forecaster 184 receives the share group prediction 178 and the individual market shares 182 and determines a Per Store SKU forecast 186 by multiplying the individual market shares 182 by the prediction for the entire share group 178.

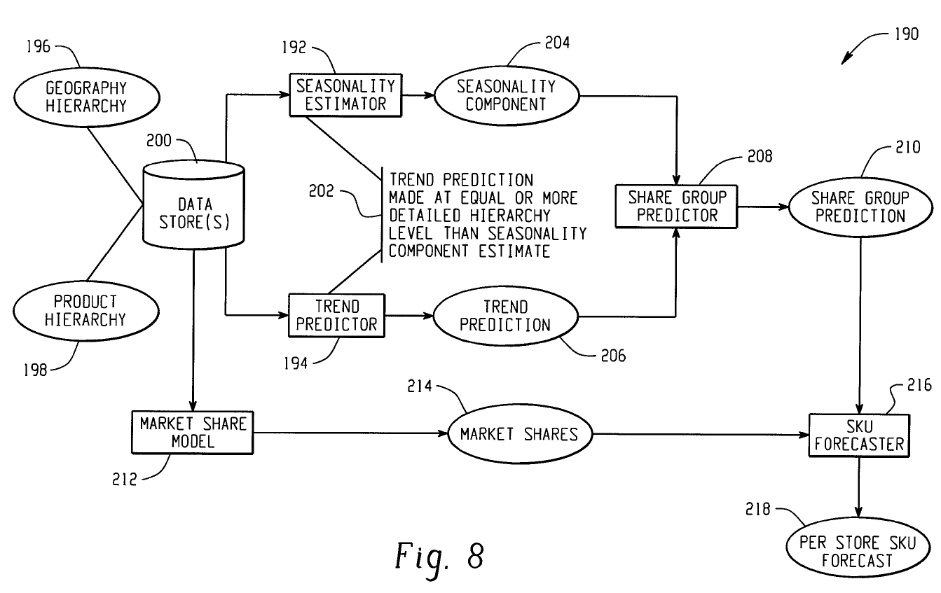

FIG. 8 is a block diagram of a model sales forecasting system and the levels used for seasonality estimates and trend predictions. A seasonality estimator 192 and a trend predictor 194 both receive geography hierarchy 196 and product hierarchy 198 data from one or more data stores 200. The seasonality estimator 192 and the trend predictor 194 use the received hierarchies to generate a seasonality component 204 and a trend prediction 206, respectively. The system of FIG. 8 notes at 202 that the trend prediction is made at an equal or more detailed hierarchy level than the seasonality component estimate. Thus, the seasonality component is estimated at an equal or higher hierarchy level. For example, seasonality may be estimated at a product subcategory level while trends may be predicted at a type level.

The benefits of predicting seasonality at a higher level can be visualized with reference to the example beer hierarchy, illustrated in FIG. 3. For example, seasonality for the beer hierarchy might be estimated at the subcategory level. This makes sense because beer may sell better in the summer when it is hotter and less in the winter when it is cool. However, trends may be predicted on the type level. For example, as the economy strengthens, more expensive imported beers may trend towards being more popular.

The seasonality component 204 and the trend prediction 206 are received by the share group predictor 208. The share group predictor utilizes the received seasonality component 204 and trend prediction 206 to calculate a prediction 210 for the entire share group, such as predicted demand or predicted sales. The market share model 212 receives historical, attribute, and other data from the one or more data stores 200 and uses the received data in generating individual market shares 214 for each of the members of the share group at issue. An SKU forecaster 216 receives the share group prediction 210 and the individual market shares 214 and determines a Per Store SKU forecast 218 by multiplying the individual market shares 214 by the prediction for the entire share group 210.

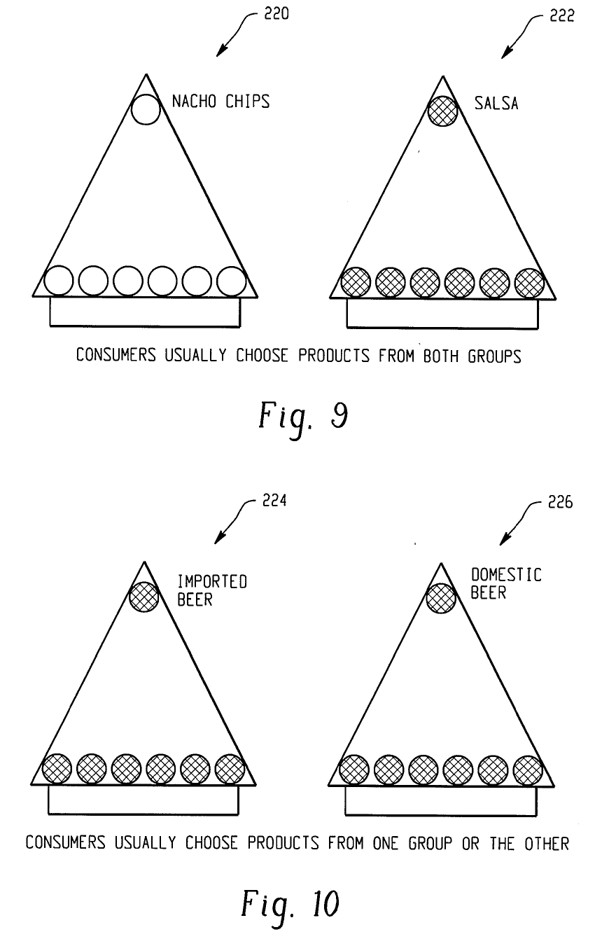

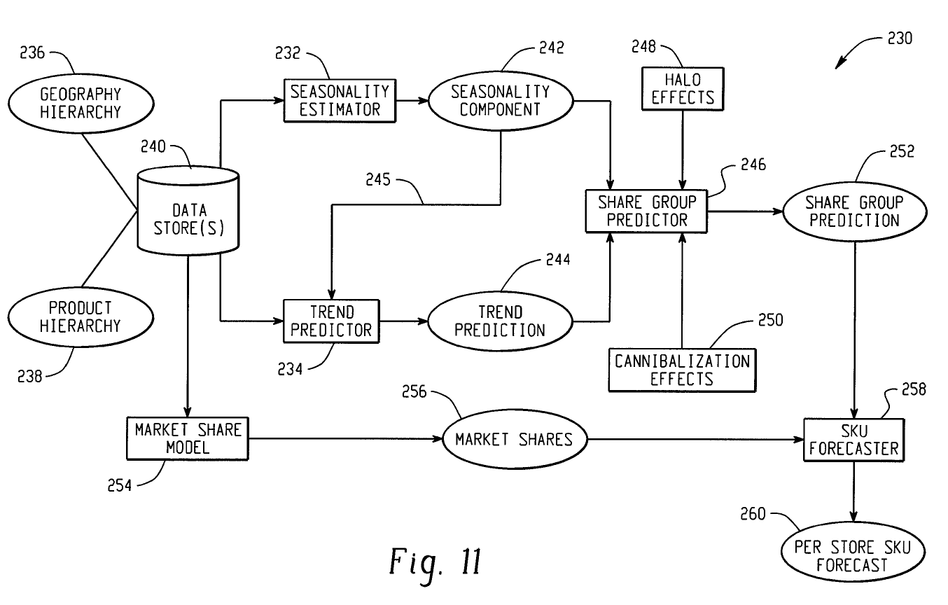

The share model may also incorporate secondary effects caused by interacting share groups. Interacting share groups are share groups that interact with each other so that sales in one share group increase or decrease based on another share group's prices and promotions. FIG. 9 depicts complementary share groups, where price and promotions of members of the nacho chips share group 220 may have a positive effect on sales in both the nacho chips share group 220 and the salsa share group 222 because customers usually choose products from both groups together. This positive effect on complementary share groups is known as a halo effect. FIG. 10 depicts competing share groups, where price and promotions of members of the imported beer group 224 may have a negative effect on sales in the domestic beer group 226 because the imported beer group 224 and the domestic beer group 226 may become competitors when the difference in pricing between the groups becomes small. This detrimental effect between competing share groups is known as a cannibalization effect.

FIG. 11 is a block diagram depicting the integration of secondary effects in the share model forecasting system. As described above, a seasonality estimator 232 and a trend predictor 234 receive geography hierarchy 236 and product hierarchy 238 data from the one or more data stores 240 to produce a seasonality component 242 and a trend prediction 244, respectively. FIG. 11 also illustrates at 245 that the trend predictor 234 may receive the generated seasonality component to deseasonalize the received data to improve trend predictions. The seasonality component 242 and the trend prediction 244 are received by the share group predictor 246. The share group predictor 246 also receives information related to halo effects 248 based on pricing and promotions in complementary share groups and cannibalization effects 250 based on pricing and promotions in competing share groups. For example, the share group predictor 246 may increase its share group prediction 252 for the salsa share group based on a halo effect 248 caused by a price reduction on chips. As another example, the share group predictor 246 may decrease its share group prediction 252 for the domestic beer share group based on a cannibalization effect 250 caused by a price reduction on import beers. The share group predictor 246 incorporates data from the calculated seasonality component 242 and trend predictions 244 as well as any halo effects 248 and cannibalization effects 250 to generate a share group prediction 252 for an entire share group 252.

The market share model 254 also receives geography hierarchy 236 and product hierarchy 238 data from the one or more data stores 240 to calculate one or more individual market shares 256. The share group prediction 252 and the individual market shares 256 are input into an SKU forecaster 258 that multiplies the individual market shares 256 by the prediction for the entire share group 252 to calculate a per store SKU forecast 260.

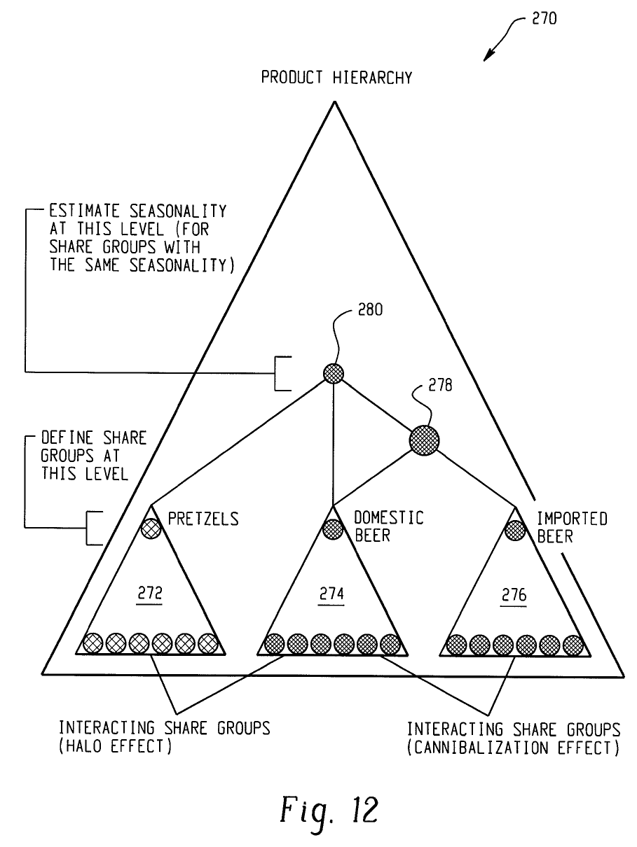

The utilization of hierarchical data structures such as the geography and product hierarchies offers increased processing speed potential based on pre-aggregations of data in the hierarchical data structures; increased targetability of results through selectability of output prediction levels; and increased flexibility over flat data constructs. FIG. 12 depicts an example of this flexibility through level selection for a seasonality estimation. As noted above, primary effects such as seasonality and trends may be estimated or predicted at different levels of the product and geography hierarchies. The product hierarchy 270 includes a number of share groups that include the pretzels share group 272, the domestic beer share group 274, and the imported beer share group 276. As noted above, seasonality may be estimated at one of several different levels of the product hierarchy 270. A user may choose to estimate seasonality at a first level 278 that incorporates both the domestic beer 274 and the imported beer 276 share groups as these groups are likely to have similar seasonality. However, it may be desirable to include other share groups by estimating seasonality at a higher level 280. Estimating seasonality at the higher level 280 includes other share groups, such as pretzels 272, that may have similar seasonality. Including other share groups having similar seasonality may improve predictive results by utilizing a more robust data set. Level selection may also be done automatically in the computer-implemented system.

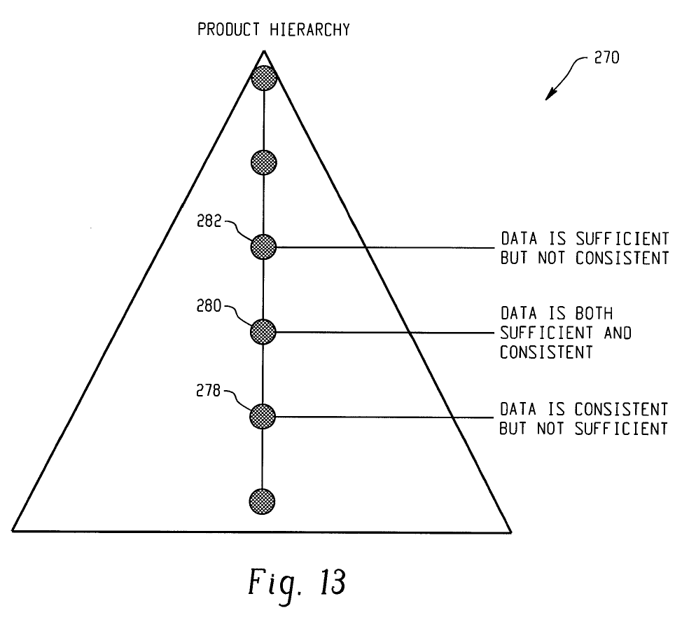

FIG. 13 depicts considerations for geography level selection for seasonality estimation. At a first level 278, which corresponds to the level 278 of FIG. 12 that includes the domestic beer 274 and imported beer 276 share groups, the data may be consistent in that the included share groups have similar seasonality, but the data may not be sufficient in that other share groups having similar seasonality may be excluded. The second level 280 corresponds to the level selected to estimate seasonality in the example of FIG. 12, where the data is consistent in that the captured share groups have similar seasonality, and the data is sufficient in that other similar share groups are not excluded. The third level 282 illustrates a disadvantage in proceeding too high up the hierarchy in selecting a seasonality estimate level, where the data becomes inconsistent. For example, the third level 282 may further include the chicken soup share group, which, being a food more likely associated with winter, may have a differing seasonality than the pretzel and beer share groups. Similar level decisions may be made with respect to the geography hierarchy and trend predictions based on the data sets and analysis needs.

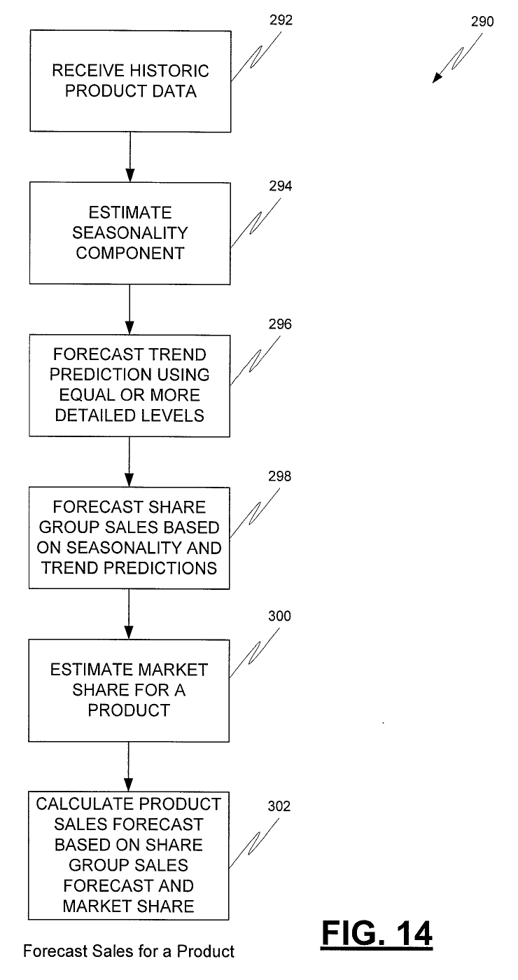

FIG. 14 is a flow diagram illustrating calculation of product sales forecasts utilizing hierarchical data. Historic product data is received from a computer-readable data store as shown at 292. A seasonality component is estimated based upon aggregate data from a first level of the geography hierarchy and a first level of the product hierarchy as shown at 294. At 296, a trend prediction is forecasted based upon aggregate data from a second level of the geography hierarchy and a second level of the product hierarchy, where equal or more detailed levels of one or both of the hierarchies are used in forecasting the trend prediction. Share group sales are forecast based on the seasonality component and the trend prediction as illustrated at 298. A market share is estimated for one or more products at 300, and a product sales forecast is calculated at 302 based upon the forecasted sales for a share group and the estimated product share.

As an example of implementation of the share model sales forecasting system, reference is made to the beer hierarchy example of FIG. 3. As shown at 102 and 104 the share groups of interest are defined as the domestic beer share group 102 and the imported beer share group 104. Seasonality may be estimated at a higher level than total demand. In this example, each subcategory level 74 shows a distinct seasonal pattern within each climate zone. Both domestic and imported beer show similar seasonality, and each market cluster within each climate zone shows a similar seasonality. Therefore, the Climate/Subcategory level is selected for estimation of seasonality. Seasonality may be estimated utilizing the Unobserved Components Model (UCM) with trend, seasonal, and holiday dummies, actual-to-regular price ratio, and available promotion support (PS) variables. Other possible models include, but are not limited to, ARIMAX, as well as two-step models such as UCM and Winters smoothing methods combined models and ARIMA and Winters smoothing methods combined models.

Total demand may be estimated at the Metro/Type level, which is below the level where seasonality is estimated. Within each climate zone, different metros can exhibit different trends (e.g., some metros may grow at a faster rate than others). Thus, total consumer demand can grow at a different speed in different metros. Similar differences in trend may exist on the product side, where demand for different types of beverages can grow at different rates. Thus, trends may be estimated at the subcategory level. Trend prediction may use a UCM model with trend, price ration, and PS variables to get estimates for price and promotion elasticities, as well as an estimate for the trend. The trend predictor may use the results of the seasonality estimate to deseasonalize the data prior to making a trend prediction.

One or more of the trend prediction, seasonality estimate, elasticities, and sales related variables are combined to obtain sales forecasts at the Metro/Type level. For a multiplicative model, forecast of total sales at this level may be calculated by multiplying the trend times the seasonality times the sales lift computed from the elasticities and historical and future values for price ration and PS variables. The sales forecasts may then be disaggregated to the Store/Subtype level such that the forecasts are of share group scope. This may be accomplished using historical sales as weights.

Using a market-share model, item based shares and share elasticities may be calculated at the Store/SKU level using an attraction model such as the Multiplicative Competitive Interaction (MCI) or multinomial logit (MNL) model. The item based shares and share elasticities may then be used to obtain a forecast market share for each item within a share group. The share-group total sales forecast and the forecast of an item's share of the share group sales are then multiplied to obtain a forecast of sales for an individual item.

While examples have been used to disclose the invention, including the best mode, and also to enable any person skilled in the art to make and use the invention, the patentable scope of the invention is defined by claims, and may include other examples that occur to those skilled in the art. Accordingly, the examples disclosed herein are to be considered non-limiting. As an illustration, many different computer configurations can be used to store hierarchical data for use in demand forecasting analysis. For example, the data may be stored in a hierarchical fashion such that low-level data (e.g., data at an SKU level) may be aggregated to a higher level (e.g., a product type level or metro region level). Summary data can appear at the higher level nodes to describe data of all of the child nodes encapsulated by the higher level node. This aggregation through hierarchical storage may be accomplished using a dedicated multidimensional database such as a MOLAP database implementation, which is specifically tailored for capturing aggregation data and making it readily available for calculations.

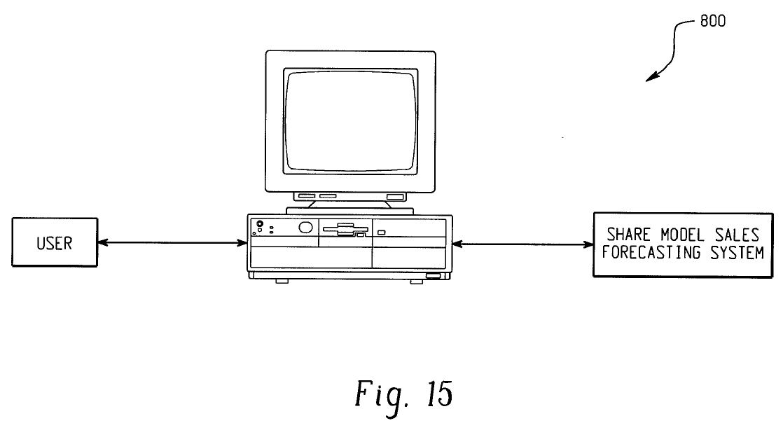

As an another illustration, the systems and methods may be implemented on various types of computer architectures, such as for example on a single general purpose computer or workstation (as shown at 800 on FIG. 15), or on a networked system, or in a client-server configuration, or in an application service provider configuration.

It is further noted that the systems and methods may include data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data may be stored and implemented in one or more different types of computer-implemented ways, such as different types of storage devices and programming constructs (e.g., data stores, RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

It is claimed:

1. A computer-implemented method of forecasting product sales utilizing historic product data that is organized with respect to a geography hierarchy and a product hierarchy, said method comprising:
receiving the historic product data from a computer-readable data store;
estimating a seasonality component based upon aggregate data from a first level of the geography hierarchy and a first level of the product hierarchy;
forecasting a trend prediction based upon aggregate data from a second level of the geography hierarchy and a second level of the product hierarchy;
wherein the second level of the geography hierarchy is at an equal or more detailed level in the geography hierarchy than the first level of the geography hierarchy, or the second level of the product hierarchy is at an equal or more detailed level in the product hierarchy than the first level of the product hierarchy;
estimating, for a product within a share group, a market share associated with the product with respect to other items in the share group;
calculating weighted marketing mix effects of a share group based on product level marketing mixes and corresponding estimated market shares within a share group;
forecasting sales for a share group based upon the seasonality component, the trend prediction, and the weighted marketing mix effects, wherein a share group is a collection of related products;
calculating, for the product within a share group, a product sales forecast based upon the forecasted sales for a share group and the estimated product market share;
storing the calculated product sales forecast in a computer-readable data store;
wherein the receiving, forecasting a seasonality prediction, forecasting a trend prediction, forecasting sales, estimating a market share, calculating a product sales forecast, and storing are all performed on one or more data processors.

2. The method of claim 1, wherein the historic product data is hierarchically stored in a MOLAP multidimensional database.

3. The method of claim 1, wherein a share group is a group of related products that: are in the same product family; are in the same product choice set; are in a set of competing products; or are substitutes for other related products in the group.

4. The method of claim 1, wherein the estimated product market share for a product is a value between 0 and 1 representing a fraction of total sales for a share group that are expected to be represented by the product.

5. The method of claim 4, wherein the step of calculating a product sales forecast further comprises multiplying the forecasted sales for a share group by the estimated product market share value to determine a product sales forecast.

6. The method of claim 1, wherein the second level of the geography hierarchy is at a more detailed level in the geography hierarchy than the first level of the geography hierarchy, or the second level of the product hierarchy is at a more detailed level in the product hierarchy than the first level of the product hierarchy.

7. The method of claim 1, wherein the second level of the geography hierarchy is at an equal level with the first level of the geography hierarchy in the geography hierarchy, and the second level of the product hierarchy is at an equal level hierarchy with the first level of the product hierarchy in the product hierarchy.

8. The method of claim 1, wherein the second level of the geography hierarchy is at an equal or more detailed level in the geography hierarchy than the first level of the geography hierarchy, and the second level of the product hierarchy is at an equal or more detailed level in the product hierarchy than the first level of the product hierarchy.

9. The method of claim 1, wherein the geography hierarchy and the product hierarchy are modeling hierarchies generated from one or more physical hierarchies and/or attribute hierarchies stored on the computer-readable data store.

10. The method of claim 1, further comprising the step of:
estimating a price elasticity and a promotion elasticity based upon aggregate data from the second level of the geography hierarchy and the second level of the product hierarchy;
wherein calculating a product sales forecast is further based upon the estimated price elasticity and the estimated promotion elasticity.

11. The method of claim 1, wherein the calculated product sales forecast is at a Store level in the geography hierarchy and an SKU level in the product hierarchy.

12. The method of claim 1, wherein the forecast of the seasonality prediction is based on a predictive model selected from the group consisting of: An Unobserved Components Model (UCM), ARIMAX, UCM and Winters smoothing methods combined models, ARIMA and Winters smoothing methods combined models, and combinations thereof.

13. The method of claim 1, wherein the forecast of the trend prediction is based on a same predictive model that the forecast of the seasonality prediction is based.

14. The method of claim 1, wherein market shares are modeled using a regression model that utilizes product attributes and marketing mix information that includes price and promotions.

15. The method of claim 1, further comprising the step of estimating a halo effect for the share group based on pricing and promotions in a complementary share group;
wherein the step of estimating a halo effect includes correlating unexplained sales in the share group in previous time periods with pricing and promotions in the complementary share group;
wherein the step of forecasting shares for a share group utilizes the estimated halo effect for the share group.

16. The method of claim 1, further comprising the step of estimating a cannibalization effect for the share group based on pricing and promotions in a competing share group;
wherein the step of estimating a cannibalization effect includes correlating unexplained sales in the share group in previous time periods with pricing and promotions in the competing share group;
wherein the step of forecasting shares for a share group utilizes the estimated cannibalization effect for the share group.

17. A computer-implemented apparatus for forecasting product sales utilizing historic product data that is stored with respect to a geography hierarchy and a product hierarchy, said apparatus comprising:
a computer-readable data store for housing the historic product data;
a seasonality estimator configured to operate on a data processor and to estimate a seasonality component based upon aggregate data from a first level of the geography hierarchy and a first level of the product hierarchy;
a trend forecaster configured to operate on the data processor and to make a trend prediction based upon aggregate data from a second level of the geography hierarchy and a second level of the product hierarchy;
wherein the second level of the geography hierarchy is at an equal or more detailed level in the geography hierarchy than the first level of the geography hierarchy, or the second level of the product hierarchy is at an equal or more detailed level in the product hierarchy than the first level of the product hierarchy;
a market share estimator configured to operate on the data processor and to estimate, for a product within a share group, a market share associated with the product with respect to other items in the share group;
a sales forecaster configured to operate on the data processor and to forecast sales for a share group based upon the seasonality component and the trend prediction, wherein a share group is a collection of related products;
a product sales forecast calculator configured to operate on the data processor and to calculate, for the product with a share group, a product sales forecast based upon the forecasted sales for a share group and the estimated product share;
wherein the calculated product sales forecast is stored in a computer-readable data store.

18. The apparatus of claim 17, wherein the geography hierarchy and the product hierarchy are modeling hierarchies generated from one or more physical hierarchies and/or attribute hierarchies stored on the computer-readable medium.

19. The apparatus of claim 17, further comprising:
an elasticity estimator configured to estimate a price elasticity and a promotion elasticity based upon aggregate data from the second level of the geography hierarchy and the second level of the product hierarchy;
wherein the sales forecaster calculates forecast sales for a share group that is further based on the price elasticity and the promotion elasticity.

20. The apparatus of claim 17, wherein the calculated product sales forecast is at a Store level in the geography hierarchy and an SKU level in the product hierarchy.

21. The apparatus of claim 17, further comprising a halo effect estimator configured to estimate a halo effect for the share group based on pricing and promotions in a complementary share group;
wherein estimating a halo effect includes correlating unexplained sales in the share group in previous time periods with pricing and promotions in the complementary share group;
wherein the sales forecaster calculates forecast sales for a share group that is further based on the estimated halo effect.

22. The apparatus of claim 17, further comprising a cannibalization effect estimator configured to estimate a cannibalization effect for the share group based on pricing and promotions in a competing share group;
wherein estimating a cannibalization effect includes correlating unexplained sales in the share group in previous time periods with pricing and promotions in the competing share group;
wherein the sales forecaster calculates forecast sales for a share group that is further based on the estimated cannibalization effect.
